(19) United States
(12) Patent Application Publication
(10) Pub. No.: US 2010/0044961 A1
(43) Pub. Date: Feb. 25, 2010

(54) Cognitive Behavioural Therapy Based Board Game

(76) Inventor: Barry Searle, Slane (IE)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/351,195

(22) Filed: Jan. 9, 2009

(30) Foreign Application Priority Data
Aug. 22, 2008 (IE) S2008/0683

(51) Int. Cl. A63F 3/00; G09B 19/22

(52) U.S. Cl. 273/249; 434/128

(57) ABSTRACT

A cognitive behavioural therapy game comprises a playing surface having a plurality of substantially contiguous spaces defining a path, at least one playing piece representing a player, a plurality of playing cards, each card raising a cognitive behavioural issue and a random number selector. On activation, the random number selector indicates to a player the number of spaces to advance their playing piece along the path and responsive to a player's playing piece landing on a space associated with a playing card, the player is required to address the issue raised by the card.

### CROSS REFERENCE TO RELATED APPLICATIONS

This application claims the benefits of Irish Patent Application No. S2008/0683 filed Aug. 22, 2008 and entitled “The ThiS Game: A CBT based therapeutic board game”, the contents of which are incorporated herein by reference.

### BACKGROUND OF THE INVENTION

This invention relates to a game utilising specific cognitive behavioural therapy (CBT) principles to maximise and enhance the therapeutic process of working with patients, in particular children and adolescents, undergoing a CBT intervention.

The main goal of cognitive therapy is to connect distortions in reasoning so that clients can live better lives. As discussed in “Cognitive Behaviour Therapy, A guide for the Practicing Clinician”, by Simos G, 2002, Brunner-Routledge, distortions in thinking are challenged in cognitive therapy by both cognitive and behavioural methods. Initially the focus is one of symptom relief but the final goal is to modify the core beliefs that are causing difficulties for the client. As acknowledged in “Cognitive Therapy with Children and Adolescents, A Casebook for Clinical Practise”, by Reinecke et Al., second edition, New York London, Guilford Press, cognitive therapy recognises the importance of the cognitive, behavioural and emotional domains but emphasises the primacy of the cognitive domain in bringing around change.

The therapeutic relationship is one of collaboration. The therapist elicits the sources of distress from the client and helps the client to clarify goals. The therapist tries to view the world from the client's perspective in a genuine way. The aim is to acknowledge the client's pain and to change his or her perspective. The therapist also challenges the client to become aware and take control of his or her behaviour.

In cognitive therapy the therapist acts as a guide and teacher. Clients are taught how certain thoughts contribute to and maintain the way they feel and behave. To maintain the collaborative relationship, the therapist elicits feedback from the client regarding the therapeutic process. This ensures client participation and deals with any problems the client may have about the process and the therapist-client relationship.

“Cognitive Behaviour Therapy, A guide for the Practicing Clinician”, by Simos G. 2002, Brunner-Routledge further discloses that the therapeutic process can be divided into three main sections: initial sessions, later sessions and ending treatment. Initial sessions concentrate on building and maintaining an alliance, setting an agenda, and exploring the elements of particular problems. As disclosed in “A clinical Guide to Think Good Feel Good”, by Stallard, 2005, England, John Wiley & Son, later sessions concentrate on ways of thinking. The focus is on eliciting the client's main beliefs and modifying them. Throughout the process the client is given activities to complete relevant to his or her difficulties, for instance keeping a mood diary (depressed clients), and role playing to enhance social skills. Approaching the end of session, discussions should take place between client and therapist that include relapse prevention and the continued utilisation of skills and strategies learned. This process is collaborative and should review steps taken in therapy up to that point. The length of treatment depends on the client's difficulties. The typical length of cognitive therapy is from twelve to fifteen sessions.

The object of the present invention is to provide a more effective method of delivering cognitive therapy to a patient.

### SUMMARY OF THE INVENTION

The present invention provides a cognitive behavioural therapy game comprising a playing surface having a plurality of substantially contiguous spaces defining a path, at least one playing piece representing a player, a plurality of playing cards, each card raising a cognitive behavioural issue, a random number selector, wherein responsive to activation, the random number selector is arranged to indicate to a player the number of spaces to advance their playing piece along the path and responsive to a player's playing piece landing on a space associated with a playing card, the player being required to address the issue raised by the card.

When participating in a game, a player is obliged to obey the boundaries and limitations introduced by the rules of the game, thereby providing the player with a defined course of action through which they must advance, overcoming expected and anticipated sets of obstacles in order to complete the game. This process of accepting a challenge, to overcome obstacles and their eventual resolution, serves to teach the player the importance of applying a necessary process to achieve a desired objective.

### BRIEF DESCRIPTION OF THE DRAWINGS

Embodiments of the invention will now be described, by way of example, with reference to the accompanying drawings, in which:

FIG. 1 illustrates a top view of a playing surface of a board game according to a first embodiment of the present invention;

FIG. 2 illustrates a top view of a random number selector according to the first embodiment of the present invention;

FIG. 3 illustrates a top view of a feedback indicator according to the first embodiment of the present invention;

FIG. 4 illustrates a top view of a playing surface of a board game according to a preferred embodiment of the present invention; and

FIG. 5 illustrates a token playing piece according to the preferred embodiment of the present invention.

### DETAILED DESCRIPTION OF THE INVENTION

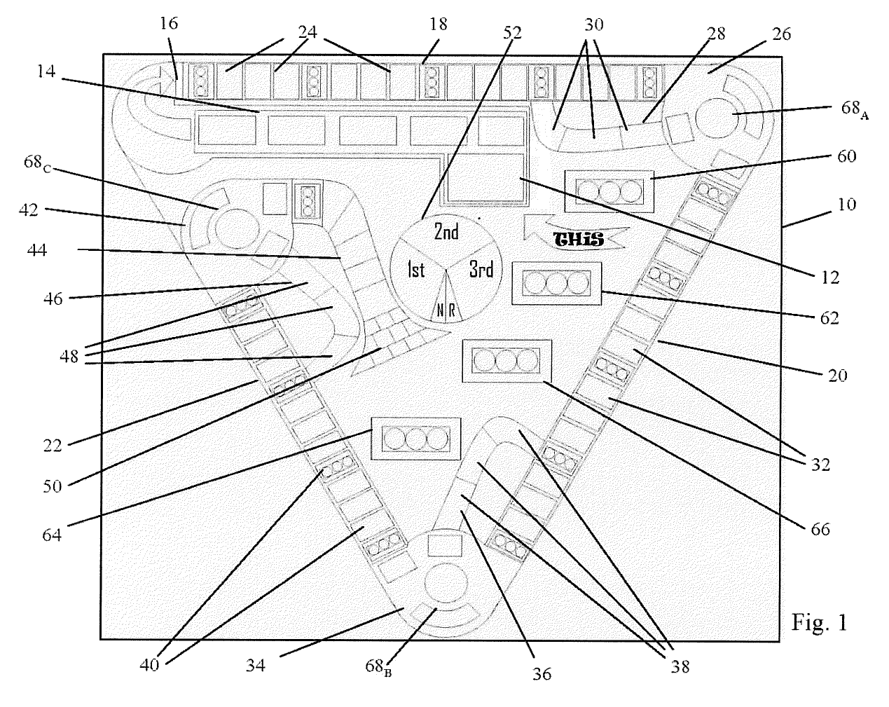

As illustrated in FIG. 1, there is provided a board game comprising a playing surface, generally indicated at 10, according to a first embodiment of the present invention.

The game is based around the concept of a normal board game and as illustrated, in the first embodiment, the game takes the format of a road race. Individual players take turns to move a token (not shown) around the playing surface 10, answering specific questions relating to their thoughts, feelings and behaviours in relation to a specific issue or problem that has been identified as problematic for the player.

For the first stage of the game, each player works their way from a starting space, 12, ‘THiS space’, towards a starting grid, 14. At the starting space 12, a specific issue or problem currently being experienced one or each player is identified. Once agreed by the players, the identified problem or issue, ‘THiS’ issue, is written on a blank card and placed on the starting space 12.

The game then revolves around each players understanding and processing of that identified issue, with emphasis placed upon each individuals thinking, feelings and actions associated with the identified issue.

Each player is then required to move through the starting grid 14. In the first embodiment, the starting grid 14 comprises five spaces, symbolising five questions relating to each player's specific problem. In the first embodiment, the five spaces are identified as the ‘Engine Shop’, ‘Chassis Shop’, the ‘Front Wheel Shop’, the ‘Back Wheel Shop’, and the ‘Engine Shop’. Each player is required to answer the question associated with each space in order to progress to a start line space 16 to enter the road race.

The playing surface 10 comprises three main paths 18, 20, and 22, through which each player must navigate in order to complete the game. In the first embodiment, the paths 18, 20 and 22, correspond to sections of the board designated as thinking, feeling and action sections respectively.

In the first embodiment, path 18, “Thinking Straight Street” comprises the starting line space 16, a plurality of intermediate spaces 24 and an ending point space 26. As illustrated in FIG. 1, the ending point space 26 takes the form of a roundabout which leads the players to path 20, “Feelings Pass” or alternatively, along a side path 28, “Review Road”, which comprises a plurality of review spaces 30, and reconnects to one of the intermediate spaces of “Thinking Straight Street” path 18.

The path 20, “Feelings Pass” comprises a plurality of intermediate spaces 32 and an ending point space 34. Again, as illustrated in FIG. 1, the ending point space 34 takes the form of a round-about which leads the players to the path 22, “Actions Drive” or alternatively, along a side path 36, “Review Road”, which comprises a plurality of review spaces 38, and reconnects to one of the intermediate spaces 32 of “Feelings Pass” path 20.

Similar to paths 18 and 20, path 22, “Actions Drive” comprises a plurality of intermediate spaces 40 and an ending point space 42. Again, as illustrated in FIG. 1, the ending point space 42 takes the form of a roundabout. The ending point space 42 leads the players to a final path 44, “Solution Street”, or alternatively to a side path 46, “Review Road”, which comprises a plurality of review spaces 48, and reconnects to one of the intermediate spaces of path 40 of path 22.

In the first embodiment, the final path 44 comprises five review spaces 48, each space being associated with a particular question related to the player's specific problem. Each player is required to answer the question associated with each space in order to progress to a finish line 50 to complete the road race.

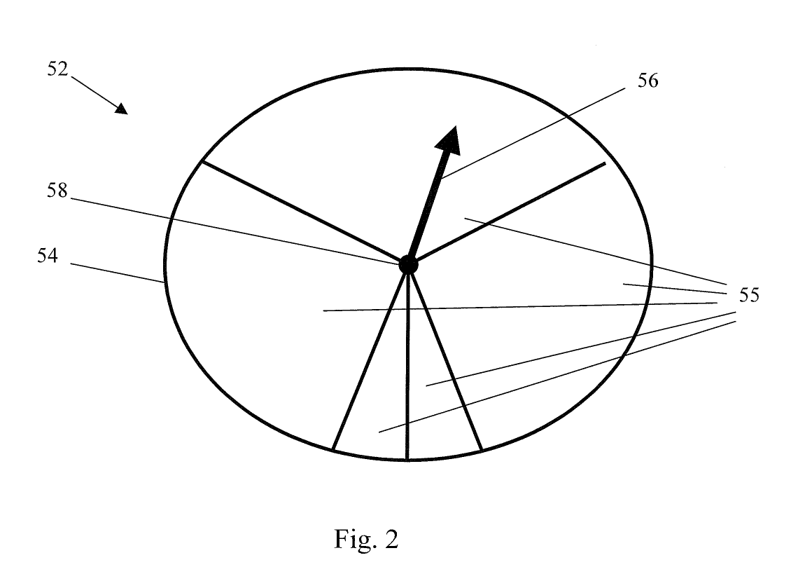

Players move their tokens through the game by randomly selecting the number of moves they can take. In the first embodiment, the game comprises a gear selector, 52. As illustrated in FIG. 2, the gear selector 52 comprises a generally circular area 54 divided into a plurality of sectors 55 and an arrow 56, which is arranged to rotate about an axis 58 central to the area 54. Each sector indicates a number of moves to be taken by the player for that turn. Thus, by spinning the arrow 56, a player may select a number of moves per turn.

In the first embodiment, the area 54 comprises five sectors, namely, 1^{st} gear, 2^{nd} gear, 3^{rd} gear, N (neutral) and R (reverse). The number of the gear indicates the moves to be taken. 1^{st}, 2^{nd} and 3^{rd} gear indicate that a player may move one, two and three spaces respectively. N (neutral) indicates that the player cannot move, and R (reverse) indicates that a player retreats one space.

It will however be appreciated that any random number generator may be utilised to indicate to a player the number of moves allocated per turn, for example, a die.

The game further comprises at least one deck of playing cards (not shown). Each player takes a turn activating the gear selector 52 to determine the number of spaces to advance their token along the playing surface 10. Depending on the space 24, 32, 40, on which their token lands, the player will be required to select a card from a deck.

The cards comprises various instructions and depending on the card chosen, the player may be required to answer questions designed to relate to the player's thinking, feelings and actions and in so doing enables an individual coping strategy associated with the resolving of the original identified problem or issue, to be constructed. Players are encouraged to respond to any answer given by their opposing player, either by asking a further clarification question or entering into a dialogue about a specific issue mentioned in their answer. Preferably, this is done at the player's discretion only if and when they think it is appropriate.

In the first embodiment, the game comprises four sets of question cards, namely thinking cards, feelings cards, action cards, and general enquiry cards. The thinking, feelings, and action cards address thinking, feeling and behavioural aspects respectively of the stated problem or issue in a step-by-step process toward developing a strategy to resolve that issue. The general enquiry cards may be question cards, beneficial cards, penalty cards, or blank cards, which allow a player to comment about the game, ask the other player a question of their choosing or make a comment about a past answer given by another player.

In the preferred embodiment, each of the thinking cards displays at least one of the following questions:

What do you think is maintaining THiS?

How does your thinking affect you?

How often do you find yourself thinking about THiS?

What do you think MOOD is?

What do you think would make your life better?

What do you think you would like to be in the future?

How does your thinking affect your behaviour?

Are your thoughts Helpful or Unhelpful. Explain

How does thinking affect you?

What do you think you would suggest to someone else who experiences THiS?

What do you think of THiS game?

What do you think others think of you?

What do you think when you feel like THiS?

How do you think you could be different?

How do you think you could change THiS?

Who do you think you are most like in your family?

How could you think differently about THiS?

What do you think about stress?

What do you think about yourself?

What do you think is the worst bit about being you?

What do you think is best about being you?

Are you a person who thinks too much?

What do you think would make THiS easier?

How does THiS affect your thoughts/

How much do you believe your thoughts about THiS?

Describe your main fear you have about THiS?

What is a worrying thought?

What do you think your future would be like without THiS?

What do you think would make a difference to THiS?

When was the last time you had worrying thoughts?

What are negative automatic thoughts?

What do you think you could do to overcome THiS?

Make a comment about thinking.

How do you think THiS started?

Does the way you think affect the way you feel?

What do you do with unhelpful thoughts?

What do you think about THiS?

What is a worrying thought?

What happens when you think THiS way?

What do you think the difference is between Pluto and Goofy?

If THiS was a colour, what colour would it be?

In the preferred embodiment, each of the feelings cards displays at least one of the following questions:

Talk about the last time you felt like THiS.

Talk about the last time you felt annoyed.

Describe how you are feeling right now.

How do your feelings affect you?

What do you feel when you think about THiS?

When did you last feel alone?

Talk about the last time you felt sad.

Talk about the last time you felt shy.

How do you look when you are angry?

How did you feel when you started playing the game?

Do your feelings about THiS make sense?

How does THiS make you feel?

When was the last time you felt relaxed?

Talk about the last time you felt annoyed.

Do your feelings affect your actions?

How do you feel about yourself?

How do you feel when THiS happens?

Name 3 different feelings and impersonate them.

How do you show you are upset?

Talk about the last time you felt depressed.

What do you fear most of all?

How do you show people you are happy?

When do you feel most relaxed?

How do you feel when THiS happens?

What do you look like when you are frustrated?

When THiS happens what do you feel you have to do?

How would you like to feel about THiS?

How does THiS affect your feelings?

How do you feel about compliments?

How do you feel when someone does something you don't like?

How do you hide your feelings?

Talk about the last time you were happy.

What do you do when you feel THiS?

How could you control how you feel.

How do you feel just before you sneeze?

In the first embodiment, each of the action cards displays at least one of the following questions:

How do your Actions affect you?

Are your Actions affected by your thinking? Explain

How do you show you are happy?

What could you do that would make a difference to THiS

How do others know when you are angry?

Describe how you learned to ride a bike.

Rub your head and pat your belly at the same time.

How does your behaviour change when THiS happens?

How do you behave when things don't go well?

How could you behave differently when THiS happens?

How does THiS affect your behaviour?

How would you behave if THiS did not happen?

What needs to change to make THiS better?

If you could change one thing to make THiS go away what would that be?

How has THiS changed you?

What could you do to change THiS?

How does your thinking affect your behaviour?

Does your behaviour make THiS better or worse?

Has your behaviour changed since THiS started?

Does THiS affect your behaviour?

What have you tried in the past to change THiS?

How have you tried to stop THiS affecting you?

Name 5 things to do to make you feel better.

Name 5 things to do that will distract you.

How does THiS affect your actions?

How do you react when THiS happens?

What can you change today that will change THiS?

What could you do differently to overcome THiS?

Turn around touch the ground jump up and down 3 times.

Does your behaviour change the way you feel. Explain.

Name 5 things you can do to stop yourself thinking THiS way?

Name 5 things you can do to stop yourself feeling THiS way.

What do you do with unhelpful thought?

What do you usually do about THiS?

Does talking about THiS help?

What would be a better way to deal with THiS?

Breathe in deeply three times and discuss the affects?

What happens when you act THiS way?

How has your behaviour changed since THiS started?

Stand up and walk backwards round the game.

How does THiS affect you?

In the first embodiment, each of the general enquiry cards displays at least one of the following questions:

Complete: I am . . . Others are . . . The world is . . . .

People minimize achievement and maximize difficulties (discuss)

What is your favourite exercise?

Gearbox trouble, miss a go.

Make a comment about THiS game.

Make a comment about something that has been said.

Engine trouble, miss a go. You have puncture miss a go.

Dangerous driving go back 2 spaces.

Speeding fine go back 1 space.

What would be different if THiS was not a problem?

Oil on the track, miss a go.

Above the clouds the sky is blue and sunny (discuss).

How often does THiS happen?

What 1 thing would you change to improve your life?

Turbo boost move forward 3 spaces.

Crashed into debris on track miss a go.

Discuss: we react emotionally before we think logically.

How could you control your feelings?

How could you control your thoughts?

How can you control your actions?

Hit the barrier miss a go.

What do others think about THiS?

The best thing ever said to me by my mum or dad was . . . .

My strengths are . . . .

The person I most admire in the world is . . . .

I feel successful when . . . .

I like myself because . . . .

I feel important when . . . .

The most important thing in the world is . . . .

What I'd never change about myself is . . . .

I am happy when . . . .

I am getting better at . . . .

I am proud of . . . .

The best thing about being me is . . . . The person I would most like to be is . . . .

I am good at . . . .

What I care most about in life is . . . .

In the first embodiment, as illustrated in FIG. 1, the playing surface 10 comprises designated positions for each sets of questions cards; thinking card spot 60, feelings cards spot 62, action cards spot 64, and general enquiry cards spot 66.

The intermediate spaces 30 of ‘Thinking Straight Street’ path 24 are designated as thinking card spaces or enquiry spaces, the intermediate spaces 34 of ‘Feelings Pass’ path 26 are designated as feelings card spaces or enquiry spaces, and the intermediate spaces 40 of ‘Thinking Straight Street’ path 28 are designated as thinking card spaces or enquiry spaces. The enquiry spaces are highlighted in order to differentiate them from thinking, feelings or action card spaces. In the first embodiment, as illustrated in FIG. 1, enquiry card spaces are depicted with an image of blank traffic lights. In the first embodiment, each card selected by a player is kept by the player until the end of the game.

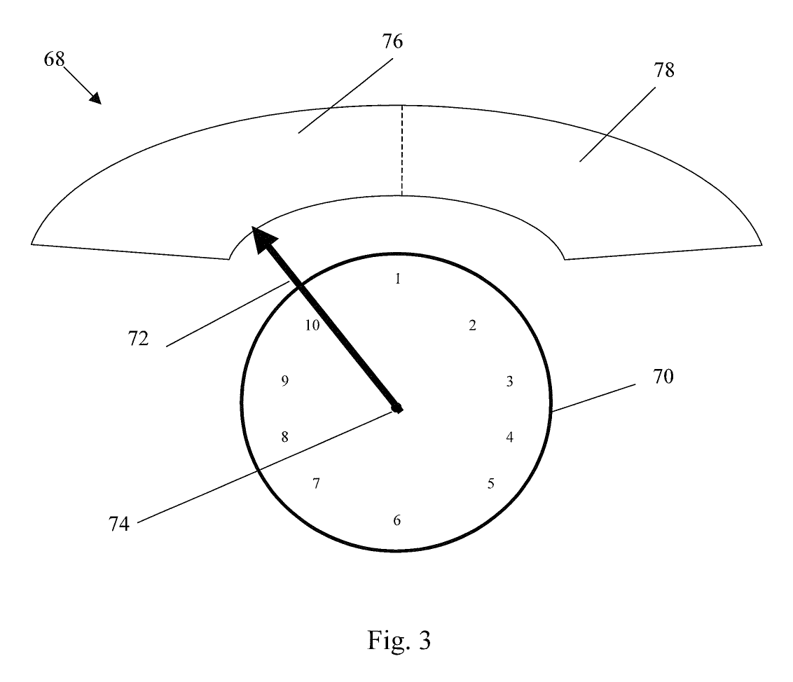

In the first embodiment, the game further comprises three feedback indicators, 68_{A}, 68_{B}, and 68_{C}, provided at the ending point spaces 26, 34 and 42 respectively, for allowing a player to indicate their satisfaction with their answers to the questions raised by the cards selected. As illustrated in FIG. 3, in the first embodiment each indicator 68_{A}, 68_{B}, and 68_{C} is a speedometer indicator comprising a dial 70 having a range of one to ten, with one being least satisfied, and an indicating arrow 72, moveable about a central axis 74 of the dial 70 to indicate a selected number. In the first embodiment, the indicating arrow 64 is also moveable between a first position 76 and a second position 78.

In order to begin the game, an issue is identified and written on a card, which is placed in the starting space 12. As outlined above, the players are required to answer the questions addressed in the starting grid 14 before proceeding to the starting line 16. At this stage, they each spin the arrow of the gear selector 52 to determine which player begins the game. In the first embodiment, the player who selected the highest number of moves begins. Should players land on the same space, the player who has just moved advances to the next space.

The players then take turns to advance along ‘Thinking Straight’ path 18, choosing thinking or enquiry cards, depending on the intermediate spaces 24 on which their token lands, and addressing the issued raised by the selected cards.

Once a player arrives at ending point space 26 of path 18, the player is asked to rate the helpfulness of their thinking in terms of the overall benefit of their journey and indicate their score on the speedometer indicator 68_{A}. This can then be noted by each player for later discussion.

The player is also required to answer a further question relating to their interpretation of their thinking being helpful or unhelpful when considering the initial problem, by moving the arrow 72 into one of the two positions provided, the first 76 indicating a helpful outcome, the second 78 indicating an unhelpful outcome. Depending on the answer, the player will then advance to ‘Feelings Pass’ path 20, or be diverted to ‘Review Road’ side path 28.

If the player has indicated that their thinking has been unhelpful in light of the initial problem, the player is diverted to ‘Review Road’ side path 28. When a player is on ‘Review Road’ side path 28, they no longer use the gear selector for determining the number of moves they may advance their associated token. Instead the player is required to land on each of the spaces 30 forming path 28 and answer the review questions associated with each space. In the first embodiment, ‘Review Road’ side path 28 comprises three spaces 30 associated with the following respective questions: 1. What do we do with unhelpful thoughts?; 2. How does your thinking affect you?; and 3. What needs to change to make your thoughts more helpful?. Once the player has travelled back onto ‘Thinking Straight’ path 18 they can once again use the gear selector 52 as before.

However, if the player has indicated that their thinking has been helpful in light of the initial problem, then the player is guided down ‘Feelings Pass’ path 20 and is permitted to select their gear and advance their token as before.

The players then take turns to advance along ‘Feelings Pass’ path 20, choosing feelings or enquiry cards, depending on the intermediate spaces 32 on which their token lands, and addressing the issued raised by the selected cards.

Once a player arrives at ending point space 34 of path 20, the player is asked to rate the usefulness of their feelings in terms of the overall benefit of their journey and indicate their score on the speedometer indicator 68_{B}. This can then be noted by each player for later discussion.

The player is also required to indicate whether their feelings make sense when considering the initial problem, by moving the arrow 72 into one of the two positions provided, the first 76 indicating yes, the second 78 indicating no. Depending on the answer, the player will then advance to ‘Actions Drive’ path 22, or be diverted to ‘Review Road’ side path 36.

If the player has indicated that their feelings don't make sense in light of the initial problem, the player is diverted to ‘Review Road’ side path 36. When a player is on ‘Review Road’ side path 36, they no longer use the gear selector for determining the number of moves they may advance their associated token. Instead the player is required to land on each of the spaces 38 forming path 36 and answer the review questions associated with each space. In the first embodiment, ‘Review Road’ side path 36 comprises three spaces 38 associated with the following respective questions: 1. How do feelings affect you?; 2. What affects the way you feel?; and 3. What one thing can you do to change your feelings?. Once the player has travelled back onto ‘Feelings Pass’ path 20 they can once again use the gear selector 52 as before.

However, if the player has indicated that their feelings make sense in light of the initial problem, then the player is guided down ‘Actions Drive’ path 22 and is permitted to select their gear and advance their token as before.

The players then take turns to advance along ‘Actions Drive’ path 22, choosing action or enquiry cards, depending on the intermediate spaces 40 on which their token lands, and addressing the issued raised by the selected cards.

Once a player arrives at ending point space 42 of ‘Actions Drive’ path 22, the player is asked to rate the usefulness of their actions in terms of the overall benefit of their journey and indicate their score on the speedometer indicator 68_{C}. This can then be noted by each player for later discussion.

The player is also required to indicate whether their actions are helpful when considering the initial problem, by moving the arrow 72 of the indicator 68_{C} into one of the two positions provided, the first 76 indicating yes, the second 78 indicating no. Depending on the answer, the player will then advance to ‘Solution Street’ path 44, or be diverted to ‘Review Road’ side path 46.

If the player has indicated that their actions weren't useful in light of the initial problem, the player is diverted to ‘Review Road’ side path 46. When a player is on ‘Review Road’ side path 46, they no longer use the gear selector for determining the number of moves they may advance their associated token. Instead the player is required to land on each of the spaces 48 forming path 46 and answer the review questions associated with each space. In the first embodiment, ‘Review Road’ side path 46 comprises three spaces 48 associated with the following respective questions: 1. How do your actions affect you?; 2. What can you do to change your actions?; and 3. What to change to make your actions more helpful?. Once the player has travelled back onto ‘Actions Drive’ path 22 they can once again use the gear selector 52 as before.

However, if the player has indicated that their actions were useful in light of the initial problem, then the player is guided to ‘Solution Street’ path 44.

Once the player has been guided to ‘Solution Street’ path 44, the player is advised that their gearbox has now broken and each player must therefore coast down ‘Solution Street’ path 44. ‘Solution Street’ path 44 comprises three spaces, each space associated with a question, which must be answered by the player, in order for to advance to the finish line 50. In the first embodiment, the three questions relate to the players thinking, feelings, and actions respectively. In this way, it is possible to construct an individual coping strategy associated with their resolving of the original identified problem or issue, the strategy being representative of 1. The way they are thinking or how they will change their thinking; 2. The way they are feeling or how they would wish to feel; and/or 3. The actions they will do or not do to enhance their ability to overcome, THiS, their original identified problem.

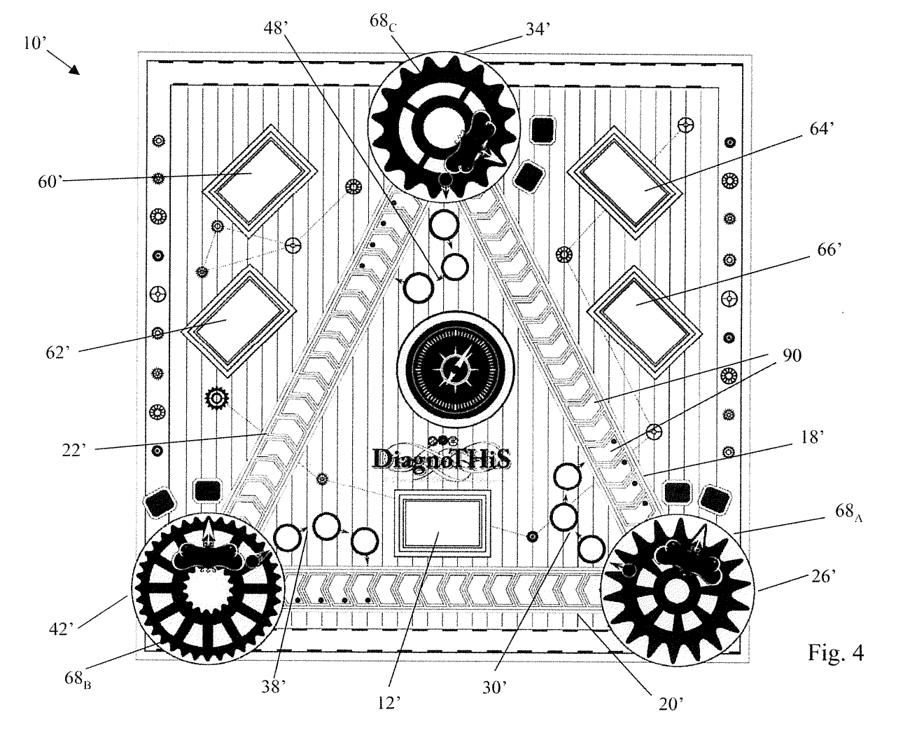

According to a second and a preferred embodiment of the invention as illustrated in FIG. 4, there is illustrated a board game comprising a playing surface, generally indicated at 10′, around which individual players take turns to move their token playing piece 80, answering specific questions relating to their thoughts, feelings and behaviours.

The playing surface 10′ comprises three paths 18′, 20′, and 22′ arranged to form a triangular shape. Paths 18′ and 20′ are connected via platform 26′ provided at a first vertex of the triangle, paths 20′ and 22′ are connected via platform 34′ provided at a second vertex, and paths 22′ and 18′ are connected via platform 42′ provided at a third vertex. In this embodiment, the platforms 26′, 34′ and 42′ are depicted as cogwheels.

First, second, and third feedback paths, 28′, 36′, and 48′, respectively, comprising a plurality of review spaces, or ‘stepping stones’, 30′, 38′ and 48′, are provided and serve to reconnect platforms 26′, 34′ and 42′ to paths 18′, 20′, and 22′ respectively.

Paths 18′, 20′, and 22′ are composed of a plurality of intermediate spaces 90, each associated with a particular deck of cards.

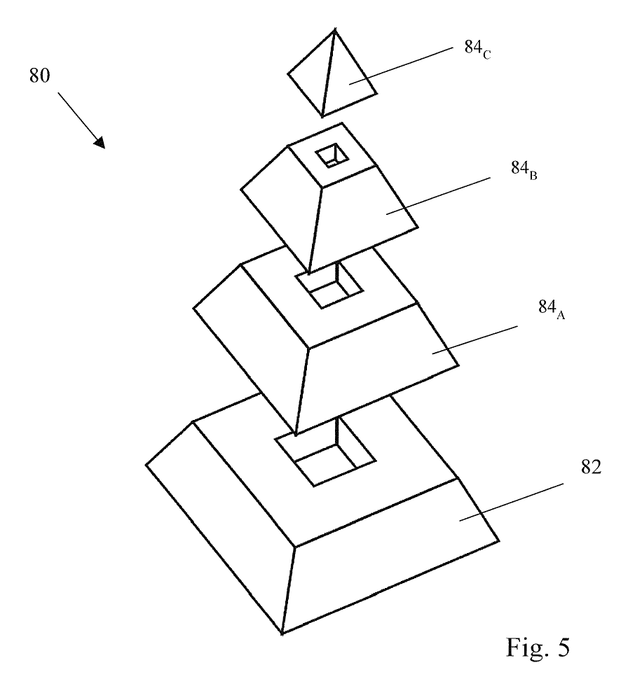

Referring to FIG. 5, in the second embodiment and in the preferred embodiment, a token playing piece 80 comprises a base piece 82 arranged to receive three separate components, 84_{A} to 84_{C}, which connect together to form a pyramid-shaped structure. Each time a player's token piece passes successfully through a platform 26′, 34′, 42′, the player is awarded a component piece 84A . . . 84_{C} to connect to the base piece 82 of their token 80.

As with the first embodiment, feedback indicators, 68_{A}, 68_{B}, and 68_{C} are provided at each platform 26′, 34′ and 42′ respectively, for allowing a player to indicate their satisfaction with the answers to the questions raised by the cards selected while advancing along path 18′, 20′, 22′ leading to the platform 26′, 34′, 42′.

If a player has indicated that they are unsatisfied with their answers, their token 80 will be redirected along stepping stones 30′, 38′, 48′, where the player will be required to answer a question relating to their thinking, feelings and actions, at each step. The player's token 80 then rejoins the path 18′, 20′, 22′ at an intermediate space 90. If a player's token is redirected along the review path stepping stones 30′, 38′, 48′, the player does not receive a component piece 84A . . . 84_{C} for their token 80.

As with the first embodiment, players move their tokens through the game by randomly selecting the number of moves they can take. In the second and preferred embodiments, the game comprises a central compass spinner, 52′. As illustrated in FIG. 4, the spinner 52′ comprises a generally circular area 54′ divided into a plurality of sectors 55′ and an arrow 56′, which is arranged to rotate about an axis 58′ central to the area 54′. Each sector indicates a number of moves to be taken by the player for that turn. Thus, by spinning the arrow 56′, a player may select a number of moves per turn.

In the second embodiment, a specific issue or problem currently being experienced one or each player is identified. Once agreed by the players, the identified problem or issue, ‘THiS’ issue, is written on a blank card and placed on the space 12′. Alternatively, a problem or issue for discussion may be randomly selected from a deck of scenario cards and placed on the space 12′.

To begin the game, each player places their token on any platform or cogwheel 26′, 34′, 42′. In the preferred embodiment, each player takes a turn activating the spinner 52′ to determine the number of spaces to advance their token along the playing surface 10′. Depending on the space 90, on which the token lands, the player will be required to select a card from a deck.

As with the first embodiment, the cards comprise thinking cards, feelings cards, action cards, and general enquiry cards. In the second embodiment, the general enquiry cards also include ‘DiagnoTHiS’ cards, which are general enquiry cards displaying the following statement: ‘Make a DiagnoTHiS completing the following I think . . . I feel . . . But/And I choose to . . . Or spin again’.

As illustrated in FIG. 4, the playing surface 10′ comprises designated positions for each sets of questions cards; thinking card spot 60′, feelings cards spot 62′, action cards spot 64′, and general enquiry cards spot 66′.

If a player's token 80 comprises less than three component parts 84_{A} to 84_{C}, and the player selects a DiagnoTHiS' card, the player must ‘spin again’ and choose another card according to the space 90 on which the token lands. If, on the other hand, the player's token comprises three component parts 84_{A} to 84_{C}, and the player selects a DiagnoTHiS' card, the player is entitled to complete the diagnosis statement and in doing so, constructs their individual coping strategy relating to the original issue, thereby winning the game.

Alternatively, according to the preferred embodiment, known as DiagnoTHiS, one player is appointed as a ‘patient’, and the remaining players adopt a role as ‘therapists’. The ‘patient’ selects a scenario card from a deck of cards, each card displaying a specific issue or problem, which then forms the central theme of the game.

In the preferred embodiment, each of the scenario cards displays at least one of the following questions:

You drink too much

You are experiencing relationship difficulties

You are experiencing work place bullying

You must inform someone close to you, about something that is devastating to them

You are caught up in a love triangle

You have been diagnosed with a terminal illness

Your behaviour is upsetting those around you or closest to you

You swear too much

You are perceived by others as being too domineering

You feel undervalued by others

You are not responsible enough

You are the victim of domestic violence

You shy away from responsibility

You have difficulty with authority and being told what to do

Your life is out or control

The situation you are in is out with your control

You have an anger management problem

You are low in mood this is affecting your outlook and daily presentation

You are paranoid about others

You are too involved with something

Others expectations of you are too high

Your expectations of self are too low

You lack motivation

You perceive yourself as worthless

You have a difference of opinion with someone close to you

You perceive that you are being held back by others

You are disillusioned with your career

You need to change the direction of your life

You have suffered a recent emotional set back

You have suffered a recent professional set back

You are unsure of your future direction professionally

You must come to terms with a difficulty experience past from the past

You lack confidence in your abilities

You perceive yourself as being undermined by others

You perceive your are opinions are unheard by others

You are faced with a daunting challenge

You are stuck in a rut

You perceive life to be passing you by

You lack challenge in your life

You lack motivation

You must pursue a forgotten goal

You are faced with a decision, to do this would upset those around you, but it would better your situation

You have been putting something off that now must be addressed

Your outlook on life is negative

You are involved in something that you know to be bad for you

You are involved in something that is exciting and fun but ultimately detrimental to you

You have experienced a recent loss of something or someone.

You are living life out with your means

You are too focused upon work to the detriment of your relationships

An aspect of your life must change, Identify

You have recently been made unemployed

Your goals in life remain unachieved

You lack confidence in yourself

You have a particular overwhelming concern/worry

In order to achieve a goal you must take a step back professionally

You suffer from work related stress

You are presented with an opportunity, in order to achieve this you must totally change your life style

An opportunity is presented to you it has huge personal and financial implications for your family do you take the opportunity

You are unable to relate to you partner

You have recently been let down badly by someone close to you

You are unfulfilled in your life

You believe in a cause that others do not support

The support of others closest to you is not forthcoming

You and your partner have a difference of opinion about an important issue

You have been alienated by your closest friends/family

You are involved in a long-term relationship, you want out,

Your partner has cheated on you but you decide to give the relationship another go

You are not happy with your physical appearance

You are faced with a moral dilemma

You discover that your best friends partner is having an affair with your partners

You have an obligation that you are unwilling to fulfill

You are facing financial restraint

You lack support for a decision you know to be correct

You are faced with the dilemma of abortion

You are disillusioned with your career

You want to change your life's direction

You must come to terms with a past difficulty

You are faced with a terminal illness

You have been told you lack compassion

You are experiencing paranoia

You are told to improve your fitness for health reasons

You are experiencing feelings of worthlessness

You are being held back by others

You have been told you must change your diet for medical reasons

You have been told you are required to take medication for the rest of your life for medical reasons

You have been informed that you are unable to have children

Your children show little regard for your decisions

You have been suspended from your job falsely

Due to a drink driving incident you have lost your license

You are careless with other people's emotions

You require a transplant of an internal organ

You have a problem with gambling

You experience ageism

You experience racism

You are perceived by others to be a bully

You are perceived by others to be a racist

You worry too much unnecessarily

You are jealous of others

You have become aware of others jealousy about you

You have received your conscription papers

The ‘patient’ places the scenario card on a space 12′ on the playing surface 10′, without displaying the scenario to the other players, or ‘therapists’.

The game is then conducted in a similar manner to that of the second embodiment. However, each of the questions displayed on the cards selected by the ‘therapist’ players, are answered by the ‘patient’ player. Based on the ‘patient’ player's answers, each of the ‘therapist’ players attempts to diagnose the scenario displayed on the undisclosed card placed on the space 12′.

In this preferred embodiment, when the ‘patient’ player selects a DiagnoTHiS' card, they simply ‘spin again’ and choose another card according to the space 90 on which the token lands.

If a ‘therapist’ player's token 80 comprises less than two component parts 84_{A} to 84_{C}, and they select a ‘DiagnoTHiS’ card, they simply ‘spin again’ and choose another card according to the space 90 on which the token lands. If, however, a ‘therapist’ player's token 80 comprises at least two component parts 84_{A} to 84_{C}, and they select a ‘DiagnoTHiS’ card, they are entitled to put forward a diagnosis in an attempt to reveal the issue associated with the ‘patient’ player as displayed on the undisclosed card placed on the space 12′, or alternatively, they can choose to ‘spin again’.

If a ‘therapist’ player makes an incorrect diagnosis, they lose a component part of their token 80 and become a ‘patient’ player.

In the preferred embodiment, the ‘patient’ player is designated the winner if they collect all three component parts of their token 80, and subsequently select a ‘DiagnoTHiS’ card from the deck. A ‘therapist’ player will only be designated the winner of the game if they correctly diagnose the ‘patient’ player's issue.

The invention is not limited to the embodiment(s) described herein but can be amended or modified without departing from the scope of the present invention.

What is claimed is:

1. A cognitive behavioural therapy game comprising:
a playing surface having a plurality of substantially contiguous spaces defining a path;
at least one playing piece representing a player;
a plurality of playing cards, each card raising a cognitive behavioural issue;
a random number selector;
wherein responsive to activation, the random number selector is arranged to indicate to a player the number of spaces to advance their playing piece along the path; and responsive to a player's playing piece landing on a space associated with a playing card, the player being required to address the issue raised by the card.

2. The game according to claim 1 wherein a first series of the spaces are associated with a first set of cards, a second series of the spaces are associated with a second set of cards, and a third series of spaces are associated with a third set of cards, and wherein the first set of cards raise questions about a player's thinking in relation to an issue, the second set of cards raise questions about a player's feelings in relation to the issue, and the third set of cards raise questions about a player's actions in relation to an issue.

3. The game according to claim 2 wherein a plurality of the first, second and third series of spaces are associated with a fourth set of cards, and wherein the fourth set of cards raise general enquiry questions, indicate that the player is to be benefited, indicate that the player is to be penalised, and/or are blank.

4. The game according to claim 1 wherein the random number selector comprises a generally circular area divided into a plurality of sectors, each sector being associated with a number, and an arrow, which is arranged to rotate about an axis central to the area in order to select a sector of the area.

5. The game according to claim 2 wherein a first end point is provided between the first series of space and the second series of spaces, a second end point is provided between the second series of spaces and the third series of spaces, and a third end point is provided between the third series of spaces and a final path, and wherein a feedback indicator is provided at each of the first, second and third points, for enabling a player to provide feedback in relation to an issue in order to allow their playing piece to proceed along the path.

6. The game according to claim 1 further comprising a feedback indicator having a dial displaying a range of satisfaction levels, and an indicating arrow, wherein the arrow is moveable about a central axis of the dial to indicate a satisfaction level.

7. The game according to claim 6 wherein the feedback indicator further comprises a section having a first location and a second location and wherein said arrow is further moveable between said first location and said second location to indicate a user's response to a question.

8. The game according to claim 5 wherein a first review path is provided between the first end point and one of the spaces of the first series of spaces, a second review path is provided between the second end point and one of the spaces of the second series of spaces, a third review path is provided between the third end point and one of the spaces of the third series of spaces and where responsive to negative feedback being indicated on the feedback indicator, a player is diverted along the first, second or third review path.

9. The game according to claim 8 wherein each of the first, second and third review paths comprises a plurality of contiguous spaces and each space is associated with a specific question which must be addressed by a player diverted along the path.

10. The game according to claim 1 wherein the playing surface further comprises a starting grid having a plurality of spaces and each space is associated with a specific question which must be addressed by a player in order to progress to a start point of the path.

11. The game according to claim 1 wherein said playing piece comprises a base piece arranged to receive a plurality of separate components.

12. The game according to claim 2 wherein said issue is disclosed to at least one player and is undisclosed to at least one player.

13. The game according to claim 12 wherein said game further comprises a fifth set of cards, each card displaying a scenario, and wherein said issue is a scenario displayed on a card selected by a player from said fifth set of cards.

14. The game according to claim 13 wherein the fourth set of cards further comprises statements permitting a player to attempt to identify the issue.
